(19) United States
(12) Patent Application Publication
(10) Pub. No.: US 2004/0156615 A1
(43) Pub. Date: Aug. 12, 2004

(54) Method and apparatus for image reproduction, method and apparatus for image recording, and programs therefor

(75) Inventor: Fumihiro Funazaki, Asaka-shi (JP)

Correspondence Address: McGinn & Gibb, PLLC, Suite 200, 8321 Old Courthouse Road, Vienna, VA, 22182-3817, US

(73) Assignee: Fuji Photo Film Co., Ltd, Minamiashigara-shi (JP)

(21) Appl. No.: 10/625,726

(22) Filed: Jul. 24, 2003

(30) Foreign Application Priority Data
Jul. 25, 2002 (JP) 216514/2002
Jul. 25, 2002 (JP) 216515/2002

(51) Int. Cl. H04N 5/781

(52) U.S. Cl. 386/46; 386/125

(57) ABSTRACT

Image data for computer processing and image data for digital video equipment using the image data for computer processing as a source can be easily reproduced from a recording medium storing the image data. A recording medium, which stores image data of a DVD-Video format or a Video-CD format and image data for computer processing, is set in a media drive. A selection screen is displayed on a TV for selecting an image area storing the image data of a DVD-Video format or a Video-CD format or an image area storing the image data for computer processing. The image data stored in the selected image area are reproduced.

### BACKGROUND OF THE INVENTION

1. Field of the Invention

The present invention relates to an image reproduction method and an image reproduction apparatus for reproducing image data stored in a recording medium wherein image data obtained by a digital camera and readable by a computer can be recorded together with image data readable by a reproduction apparatus using a DVD-Video or a Video-CD format. Furthermore, the present invention relates to a program that causes a computer to execute the image reproduction method.

The present invention also relates to an image recording method and an image recording apparatus for recording, in a recording medium, image data obtained by a digital camera and readable by a computer and image data readable by a reproduction apparatus using a DVD-Video or a Video-CD format. Furthermore, the present invention relates to a program that causes a computer to execute the image recording method.

2. Description of the Related Art

Digital still image data or digital moving image data obtained by photography with a digital camera or the like are recorded in a recording medium such as a memory card and a CD-R according to a computer-readable recording method. For this reason, in order to reproduce still image data or moving image data obtained by a digital camera (hereinafter simply referred to as image data), booting up a computer having software for image data reproduction installed therein is necessary, which makes image viewing annoying. Furthermore, a user needs to have a computer therefor, and installation of the software for viewing the image data is also necessary.

Meanwhile, a DVD player enables reproduction of moving image data recorded in a DVD according to a DVD-Video format or moving image data recorded in a CD-R according to a Video-CD format, with use of a household TV set. Furthermore, a DVD player also enables reproduction of music recorded in a CD. Display of still image data representing a still image recorded in a DVD or CD with use of a DVD player is also becoming a reality. Therefore, if a user records, in a recording medium, image data obtained by a digital camera or obtained by reading images recorded on a film, the user can appreciate the images he/she photographed with his/her friends or family by using a household TV set for display.

Meanwhile, a recording medium having a first image area and a second image area has been proposed. The first image area is used for recording image data to be handled by a computer and the second image area is used for recording image data dedicated to digital video equipment using the image data in the first image area as a source. By using such a recording medium, reproduction of an image obtained by a digital camera becomes possible with use of a TV set connected to digital video equipment such as a DVD player, without a computer.

However, in the case where a DVD player that can reproduce still image data is used for reproducing image data stored in a recording medium having the first image area and the second image area, the DVD player cannot recognize the two image areas. Therefore, the DVD player can reproduce neither the image data for computer processing nor the image data for digital video equipment. Even if the DVD player can reproduce the image data, only the image data for digital video equipment can be reproduced in many cases.

Meanwhile, it is possible for a computer to reproduce both the image data for computer processing and the image data for digital video equipment if a hierarchical structure of the recording medium is traced by file management software. However, tracing the hierarchical structure is extremely troublesome for a user and the user also needs to spend time booting up a computer.

When image data are recorded in a recording medium, writing software installed in a computer is used. Such writing software displays thumbnail images of image data sets obtained by a digital camera for selection of the image or images to be written, and receives an input of a writing instruction. In this manner, the writing software writes the selected image data set or sets in a recording medium. At this time, a data size of each of the image data sets is displayed on a monitor connected to the computer, and the image data set or sets can be selected or cancelled with reference to the data size. Furthermore, a quality of the images can be adjusted, or a length of audio data can be reduced in the case of audio data, according to the data size. In this manner, the image data sets can be selected so as not to exceed the capacity of the recording medium.

However, in the case of the recording medium having the first and second image areas, there is no method of confirming the size of image data in the two image areas. Therefore, when image data are recorded in the recording medium, how to adjust the number or quality of the image data is not known at all. Consequently, an error due to the size of the data exceeding the capacity of the recording medium may occur after starting recording, or the recording medium cannot be used any more in the worst-case scenario.

### SUMMARY OF THE INVENTION

The present invention has been conceived based on consideration of the above circumstances. An object of the present invention is therefore to easily reproduce image data stored in a recording medium wherein the image data are stored for computer processing and for digital video equipment that uses the image data for computer processing as a source.

Another object of the present invention is to easily confirm a size of image data for computer processing and a size of image data for digital video equipment that uses the image data for computer processing as a source when the image data for computer processing and for digital video equipment are recorded in a recording medium.

An image reproduction apparatus of the present invention is an image reproduction apparatus for reproducing first image data and second image data recorded in a recording medium having a first image area for storing the first image data for computer processing and a second image area for storing the second image data for digital video equipment using the first image data as a source. The image reproduction apparatus comprises:

display control means for displaying on display means a selection screen for receiving selection of the first image area or the second image area;

selection reception means for receiving the selection of the first image area or the second image area in the selection screen; and

reproduction control means for reproducing the first image data in the first image area in the case where the first image area has been selected and for reproducing the second image data in the second image area in the case where the second image area has been selected.

An image reproduction method of the present invention is an image reproduction method for reproducing first image data and second image data recorded in a recording medium having a first image area storing the first image data for computer processing and a second image area storing the second image data for digital video equipment using the first image data as a source. The image reproduction method comprises the steps of:

displaying on display means a selection screen for receiving selection of the first image area or the second image area;

receiving the selection of the first image area or the second image area in the selection screen; and

reproducing the first image data stored in the first image area in the case where the first image area has been selected; and

reproducing the second image data stored in the second image area in the case where the second image area has been selected.

The image reproduction method of the present invention may be provided as a program to cause a computer to execute the image reproduction method.

According to the image reproduction apparatus and the image reproduction method of the present invention, upon reproduction of the first image data for computer processing recorded in the first image area of the recording medium and upon reproduction of the second image data recorded in the second image area of the recording medium for digital equipment using the first image data as a source, the selection screen for receiving selection of the first image area or the second image area is displayed on the display means, and either the first image area or the second image area is selected in the selection screen. In the case where the first image area has been selected, the first image data recorded in the first image area are reproduced. In the case of selection of the second image area, the second image data in the second image area are reproduced. Therefore, the first image data or the second image data can be selectively reproduced with ease from the recording medium.

An image recording apparatus of the present invention is an apparatus for recording, in a recording medium, first image data for computer processing and second image data for digital video equipment using the first image data as a source, and the image recording apparatus comprises:

display control means for calculating a first data size regarding the first image data and a second data size regarding the second image data, and for displaying the first data size and the second data size on display means.

An image recording method of the present invention is a method of recording, in a recording medium, first image data for computer processing and second image data for digital video equipment using the first image data as a source, and the image recording method comprises the steps of:

calculating a first data size regarding the first image data and a second data size regarding the second image data; and

displaying the first data size and the second data size on display means.

The image recording method of the present invention may be provided as a program to cause a computer to execute the image recording method.

According to the image recording apparatus and the image recording method of the present invention, upon recording in the recording medium the first image data for computer processing and the second image data for digital video equipment using the first image data as a source, the first data size and the second data size are respectively calculated for the first image data and the second image data, and the first data size and the second data size are displayed on the display means. Therefore, with reference to the first data size and the second data size displayed on the display means, the first image data and the second image data can be reduced or increased, or image quality thereof can be changed. In this manner, the first image data and the second image data can be recorded in the recording medium within capacity of the recording medium.

### BRIEF DESCRIPTION OF THE DRAWINGS

FIGS. 1A and 1B are data maps showing data structures in, recording media used in an embodiment of an image reproduction apparatus and in an embodiment of an image recording apparatus of the present invention;

FIGS. 2A to 2D are data maps showing structures of image areas in the recording media used in the embodiments;

FIGS. 3A to 3C show examples of information in directory areas included in the image areas in the recording media;

FIGS. 4A and 4B show examples of image data recorded in image data areas of the recording media;

FIG. 5 is a block diagram showing a configuration of a DVD player adopting the image reproduction apparatus of the embodiment;

FIGS. 6A and 6B show examples of a selection screen;

FIGS. 7A to 7C are examples of a data selection screen;

FIG. 8 is a flow chart showing procedures carried out in the image reproduction apparatus;

FIG. 9 is a block diagram showing a configuration of the image recording apparatus of the embodiment;

FIG. 10 is a flow chart showing procedures carried out in the image recording apparatus;

FIG. 11 is a flow chart showing procedures for displaying a first image data size;

FIG. 12 is a flow chart showing procedures for displaying a second image data size; and

FIG. 13 shows an example of how the first image data size and the second image data size are displayed.

### DESCRIPTION OF THE PREFERRED EMBODIMENTS

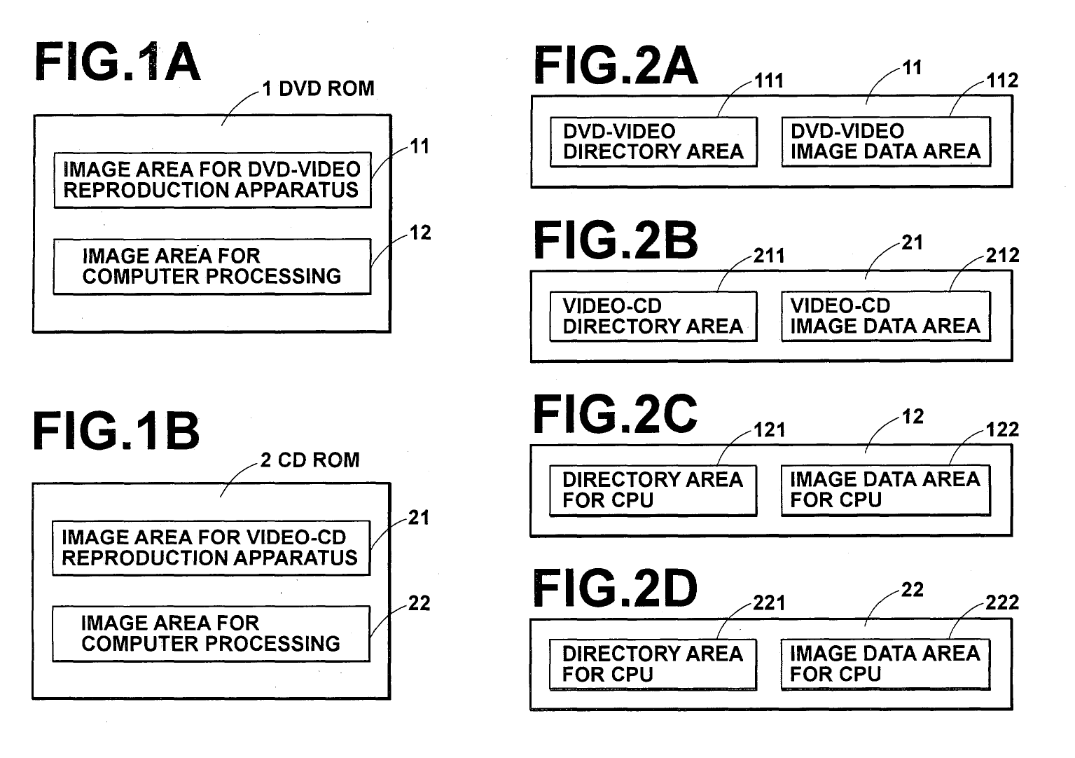

Hereinafter, embodiments of an image reproduction apparatus and an image recording apparatus of the present invention will be explained with reference to the accompanying drawings. FIGS. 1A and 1B are data maps that respectively show data structures in recording media of a DVD format and a CD format used in the embodiments.

In the embodiments, the data structure of the recording medium of the DVD format, which is represented by a DVD-ROM 1 shown in FIG. 1A, has an image area 11 for a DVD-Video reproduction apparatus and an image area 12 for computer processing. The data structure of the recording medium in the CD format, which is represented by a CD-ROM 2 shown in FIG. 1B, has an image area 21 for a Video-CD reproduction apparatus and an image area 22 for computer processing.

A digital image data set or digital image data sets having a data structure enabling reproduction by a DVD-Video reproduction apparatus (hereinafter referred to as the DVD-Video image data sets) are written in the image area 11, while a digital image data set or digital image data sets having a data structure enabling reproduction by a Video-CD reproduction apparatus (hereinafter referred to as the Video-CD image data sets) are written in the image area 21. Digital image data sets having a data structure enabling recording, reproduction, and printing with use of a personal computer or the like are written in the image areas 12 and 22.

The image data sets for computer processing are recorded in the image areas 12 and 22 according to DCF (Design rule for Camera File system) as a file format for a digital camera. In order to identify the image data sets for printing, frame numbers according to the DCF format are used so that printing thereof can be ordered with an outside service provider.

FIGS. 2A to 2D are data maps showing structures of the image areas in the recording media used in the embodiments. FIG. 2A shows the structure of the image area 11 for a DVD-Video reproduction apparatus, and FIG. 2B shows the structure of the image area 21 for a Video-CD reproduction apparatus. FIG. 2C shows the structure of the image area 12 for computer processing, and FIG. 2D shows the structure of the image area 22 for computer processing.

In FIG. 2A, the structure of the image area 11 for a DVD-Video reproduction apparatus comprises a DVD-Video directory area 111 and a DVD-Video image data area 112. In FIG. 2B, the structure of the image area 21 for a Video-CD reproduction apparatus comprises a Video-CD directory area 211 and a Video-CD image data area 212. In FIG. 2C, the structure of the image area 12 for computer processing comprises a directory area 121 for CPU and an image data area 122 for CPU (hereinafter referred to as the CPU directory area 121 and the CPU image data area 122). In FIG. 2D, the structure of the image area 22 for computer processing comprises a directory area 221 for CPU and an image data area 222 for CPU (hereinafter referred to as the CPU directory area 221 and the CPU image data area 222).

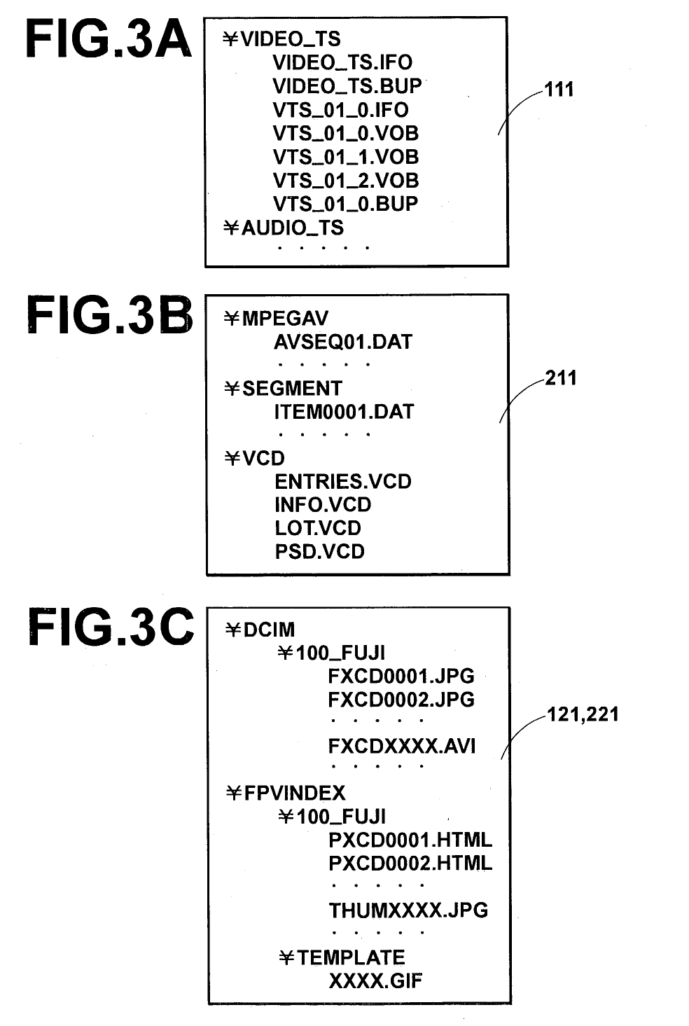

File information is written in the DVD-Video directory area 111 as will be explained later with reference to FIG. 3A. The DVD-Video image data sets are written in the DVD-Video image data area 112.

File information is written in the Video-CD directory area 211 as will be explained later with reference to FIG. 3B. The Video-CD image data sets are written in the Video-CD image data area 212.

File information is written in the CPU directory area 121 as will be explained later with reference to FIG. 3C. Digital image data sets in a data format that enables recording, reproduction, and printing with use of a computer having a DVD-Video reproduction apparatus are written in the CPU image data area 122.

The file information that will be explained later with reference to FIG. 3C is also written in the CPU directory area 221. Digital image data sets in a data format that enables recording, reproduction, and printing with use of a computer having a Video-CD reproduction apparatus are written in the CPU image data area 222.

FIGS. 3A to 3C show examples of the information in the directory areas included in the image areas of the recording media used in the embodiments. FIG. 3A shows an example of the information in the DVD-Video directory area 111, while FIG. 3B shows an example of the information in the Video-CD directory area 211. FIG. 3C shows an example of the information in the CPU directory areas 121 and 221. In each of the directory areas are written a file name of each of the image data sets stored in the corresponding image data area, allocation information necessary for accessing the respective image data sets, a compression method of the image data sets, a coding method including an error correction code, and an encryption key necessary for coding, for example.

More specifically, “¥Video_TS” in the DVDdirectory area 111 represents a directory of video information for digital video equipment, and in the directory are written video management information (VIDEO_TS.IFO), video management information back-up (VIDEO_TS.BUP), video title set information (VTS_{—}01 _IFO), titled video object set information that represents moving image data files (VTS_{—}01_{—}0.VOB, VTS_{—}01_{—}1.VOB, and VTS_{—}01_{—}2.VOB) and video title set information back-up (VTS_{—}01_{—}0.BUP).

In the Video-CD directory area 211, “¥MPEGAV” and “¥SEGMENT” refer to directories for moving image data files, and “¥VCD” refers to a directory for Video-CD format files. “INFO.VCD” refers to Video-CD information, and version information on a Video-CD and track composition thereof is recorded therein, for example.

In the CPU directories 121 and 221, “¥DCIM” refers to a directory for writing original images obtained by a digital camera according to the DCF format. Under the ¥DCIM directory, a directory “¥100_FUJI” is generated where still image data sets obtained by a digital camera according to a JPEG format and moving image data sets according to an AVI format are stored. A directory “¥FPVINDEX” is used to write therein image data sets comprising an html file or html files for viewing images on a personal computer (hereinafter referred to as the html files as shown in FIG. 3C). Under the ¥FPVINDEX directory, a directory “¥100_FUJI” is generated to store the files in an html format and thumbnail files (THUMXXX.JPG) representing the still images and the moving images. A directory “¥TEMPLATE” is a directory for writing parts of the html files therein.

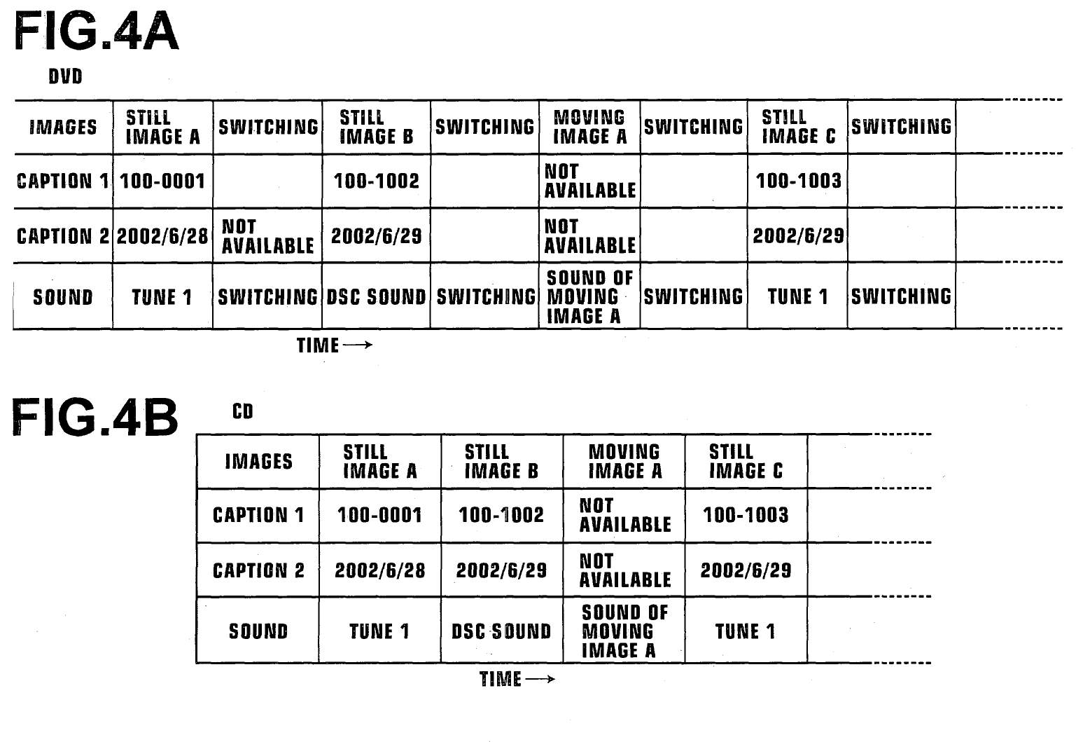

FIGS. 4A and 4B show examples of the image data sets to be written in the image data areas of the recording media in the embodiments. FIG. 4A shows the image data sets in the DVD-Video image data area 112, and FIG. 4B shows the image data sets in the Video-CD image data area 212.

In the DVD-Video image data area 112 are recorded repetitive images generated by resizing each of frames of the image data sets according to the DVD-Video format (the word “frames” is also used for the moving image data sets) written in the CPU image data area 122. In the case of still images, the number of repetition is determined so as to enable reproduction of the still images as a slide-show style moving image wherein each of the still images is shown for 5 seconds, for example.

When the image data sets are recorded in the DVD-Video image data area 112, a setting of a DVD subtitle stream area (wherein character information such as the frame numbers and the date of photography can be written), a setting of a switching effect such as 2-wipe and dissolve between frames, a setting of audio data for each of the image data sets, and a setting of the audio data such as fade-in or fade-out can determined. By using the settings described above, a caption can be displayed or the audio data can be reproduced during image reproduction. In this manner, a desired visual effect or sound effect can be given at each time the images are changed from one to another.

In the Video-CD image data area 212 are recorded repetitive images generated by resizing each of frames of the image data sets according to the Video-CD format (the word “frames” is also used for the moving image data sets) written in the CPU image data area 222. In the case of still images, the number of repetition is determined so as to enable reproduction of the still images as a slide-show style moving image wherein each of the still images is shown for 5 seconds, for example.

When the image data sets are recorded in the Video-CD image data area 212, a setting of a CD.subtitle stream area (wherein character information such as the frame numbers and the date of photography can be written) and a setting of audio data for each of the image data sets can be determined. By using the settings described above, a caption can be displayed or the audio data can be reproduced during image reproduction.

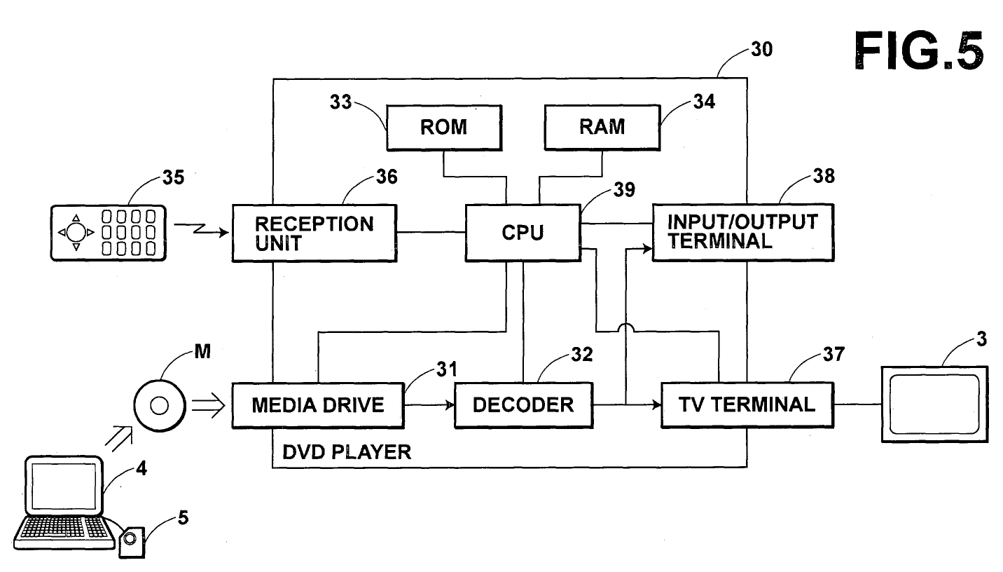

FIG. 5 is a block diagram showing a configuration of a DVD player adopting the image reproduction apparatus of the embodiment of the present invention. The DVD player is used for reproduction of the image data sets recorded in the above-described DVD-ROM having the image data sets in a DVD-Video format and the image data sets for computer processing, and for reproduction of the image data sets in the above-described CD-ROM having the image data sets in a Video-CD format and the image data sets for computer processing.

As shown in FIG. 5, a DVD player 30 in this embodiment comprises a media drive 31, a decoder 32, a ROM 33, a RAM 34, a reception unit 36, a TV terminal 37, an input/output terminal 38, and a CPU 39. The media drive 31 accepts insertion of a recoding medium M having the DVD-Video or Video-CD format image data sets and the computer processing image data sets, and reads the image data sets from the recording medium M. The decoder 32 decodes the image data sets. The ROM 33 stored a program and various kinds of information for reproduction or the like of the image data sets. The RAM 34 temporarily stores the data and is used as a work area. The reception unit 36 receives an instruction from a remote controller 35. The TV terminal 37 is used for connecting a TV set 3 (hereinafter referred to as the TV 3). The input/output terminal 38 uses a USB standard, an IEEE standard or the like, for connecting an external apparatus such as a memory card reader, a hard disc, or a printer. The CPU 39 controls the media drive 31, the decoder 32, the ROM 33, the RAM 34, the reception unit 36, the TV terminal 37, and the input/output terminal 38.

A personal computer 4 records in the recording medium M the image data sets obtained by a digital camera 5 and the DVD-Video or Video-CD format image data sets using the computer processing image data sets as a source.

The image data sets recorded in the recording medium M have been compressed according to an MPEG or JPEG format, for example. The decoder 32 decompresses the image data sets recorded in the recording medium M, and inputs the image data sets to the TV terminal 37 for reproduction thereof.

The ROM 33 stores an operation program of the DVD player 30. The operation program causes the CPU 39 to carry out various operations including image data reproduction, and the operations of the DVD player 30 are carried out based on instructions from the remote controller 35 received by the reception unit 36.

When the recording medium M is inserted in the media drive 31, whether the recording medium M is the DVD-ROM or the CD-ROM is judged first. In the case of DVD-ROM, whether the image area 11 for a VD-Video reproduction apparatus and the image area 12 for computer processing are recorded therein is judged. In the case of CD-ROM, whether the image area 21 for a Video-CD reproduction apparatus and the image area 22 for computer processing are recorded therein is judged.

In the case where the two image areas or more have been found in the recording medium M as a result of judgment, a selection screen for selection from the image areas is generated and displayed on the TV 3.

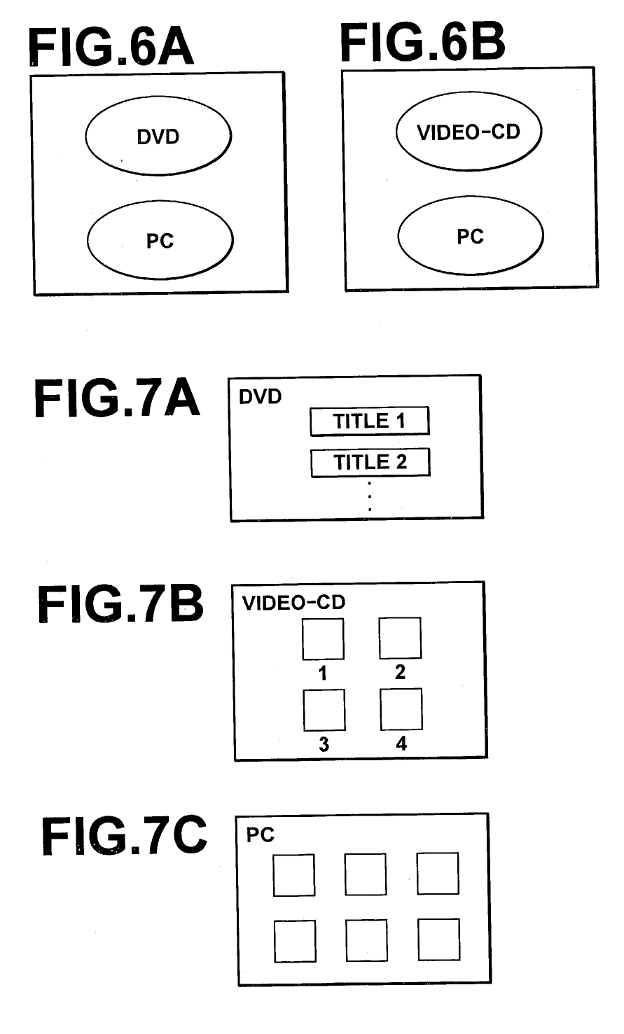

FIGS. 6A and 6B are examples of the selection screen. FIG. 6A shows the selection screen displayed in the case where the recording medium M is the DVD-ROM having the image area 11 for a DVD-Video reproduction apparatus and the image area 12 for computer processing. FIG. 6B shows the selection screen displayed in the case where the recording medium M is the Cb-ROM having the image area 21 for a Video-CD reproduction apparatus and the image area 22 for computer processing.

As shown in FIG. 6A, in the case where the recording medium M is the DVD-ROM having the image area 11 for a DVD-Video reproduction apparatus and the image area 12 for computer processing, commands “DVD” and “PC” are shown in the selection screen. In the case where the recording medium M is the CD-ROM having the image area 21 for a Video-CD reproduction apparatus and the image area 22 for computer processing, commands “VideoCD” and “PC” are displayed so as not to be confused with a music CD.

A user who wishes to reproduce the data selects a desired one of the commands with use of the remote controller 35, and a data selection screen corresponding to the selected command is displayed on the TV 3.

FIGS. 7A to 7C show examples of the data selection screen. FIG. 7A shows the data selection screen displayed in the case where the command “DVD” has been selected, and FIG. 7B shows the data selection screen displayed in the case where the command “VideoCD” has been selected. FIG. 7C is the data selection screen shown in the case of selection of the command “PC”.

As shown in FIG. 7A, the titles of the DVD-Video format image data sets are displayed in the data selection screen for the DVD command. When the user selects a desired one of the titles with use of the remote controller 35, the image data set corresponding to the selected title is reproduced.

In the case of selection of the VideoCD command, the data selection screen comprising thumbnail images of the Video-CD format image data sets is displayed, as shown in FIG. 7B. When the user selects a desired one of the thumbnail images with use of the remote controller 35, the image data set corresponding to the selected thumbnail image is reproduced.

As shown in FIG. 7C, in the case where the PC command has been selected, the data selection screen comprising thumbnail images of the image data sets for computer processing is displayed. When the user selects a desired one of the thumbnail images with use of the remote controller 35, the image data set corresponding to the selected thumbnail image is reproduced. By pressing a Right or Left button in the remote controller 35 during reproduction of the image data set, the image data set whose filename comes immediately before or after the current image data set can be displayed sequentially.

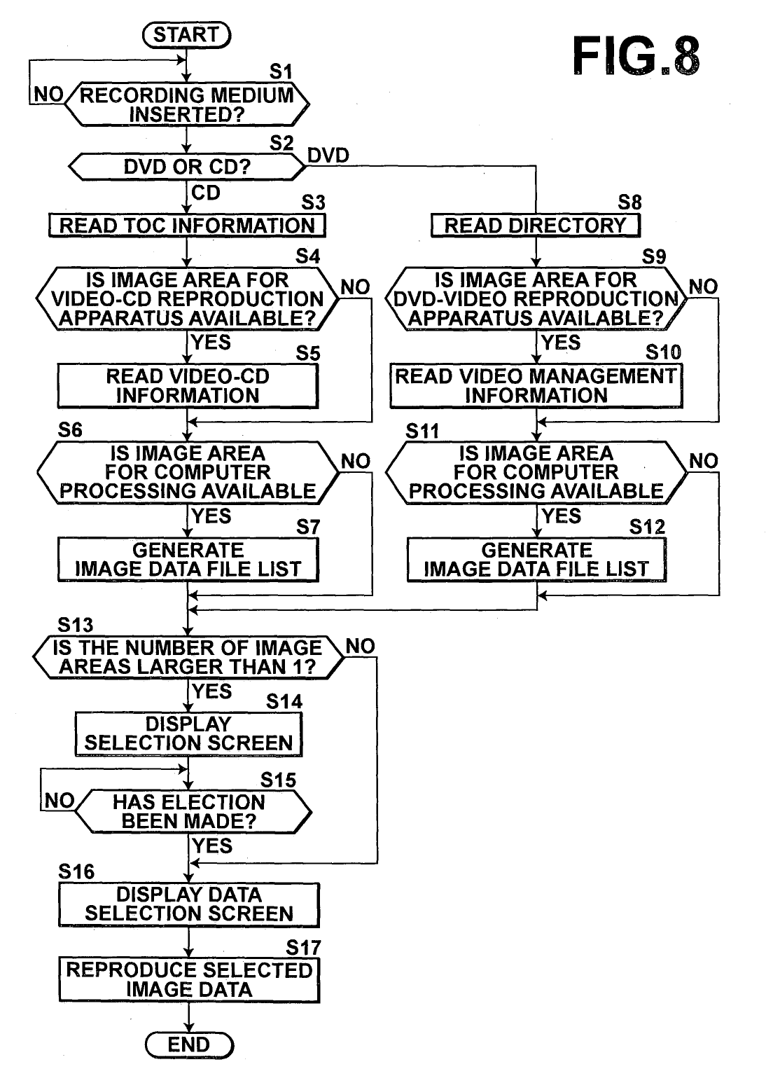

The operation of the image reproduction apparatus in this embodiment will be explained next. FIG. 8 is a flow chart showing procedures carried out in the image reproduction apparatus. Whether or not the recording medium M has been inserted in the media drive 31 is judged (Step S1). If a result at Step S1 is affirmative, whether the recording medium M is the DVD-ROM or the CD-ROM is then judged (Step S2).

In the case of CD-ROM, TOC information comprising track numbers and starting time data corresponding to each of the track numbers is read from a read-in area allocated at the top of the CD-ROM (Step S3). Whether the recording medium M has the image area 21 for a Video-CD reproduction apparatus is then judged (Step S4). If a result at Step S4 is affirmative, the Video-CD information is read (Step S5) Whether the recording medium M has the image area 22 for computer processing is then judged (Step S6). If a result at Step S6 is affirmative, a list of the file names of the image data sets recorded in the image area 22 for computer processing is generated for image reproduction (Step S7). If the result at Step S4 is negative, the process goes to Step S6.

In the case where the recording medium M has been judged to be the DVD-ROM at Step S2, the directory in the DVD-ROM is read (Step S8). Whether the recording medium M has the image area 11 for a DVD-Video reproduction apparatus is then judged (Step S9). If a result at Step S9 is affirmative, the video management information is read (Step S10). Whether the recording medium M has the image area 12 for computer processing is then judged (Step S11). If a result at Step S11 is affirmative, a list of the file names of the image data sets recorded in the image area 12 for computer processing is generated for image reproduction (Step S12). If the result at Step S9 is negative, the process goes to Step S11.

Whether the number of the image areas recorded in the recording medium M is larger than one is then judged (Step S13). In the case where the result at Step S6 or Step S11 is negative, the process goes to Step S13. If a result at Step S13 is affirmative, the selection screen shown in FIG. 6 is displayed on the TV 3 (Step S14). Whether or not the user has carried out command selection in the selection screen is judged (Step S15). If a result at Step S15 is affirmative, the data selection screen shown in FIG. 7 is displayed on the TV 3 (Step S16). If the result at Step S13 is negative, the process goes to Step S16. The image data set selected in the data selection screen is displayed (Step S17) to end the operation.

As has been described above, in the image reproduction apparatus, when the image data sets are reproduced from the recording medium M having the image data sets of the DVD-Video format or the Video-CD format and the image data sets for computer processing, the selection screen is displayed on the TV 3 for receiving selection of the image area, and the image area having the image data sets to be reproduced is selected in the selection screen. Therefore, selective reproduction of the image data sets can be carried out easily regarding the recording medium M having the DVD-Video or Video-CD format image data sets and the image data sets for computer processing.

The image recording apparatus of the embodiment of the present invention will be explained next. Data structures in a recording medium wherein image data sets are recorded by the image recording apparatus in this embodiment, data maps thereof, information of directory areas in image areas in the recording medium, and the image data sets written in the image data areas of the recording medium are the same as those shown in FIGS. 1 to 4.

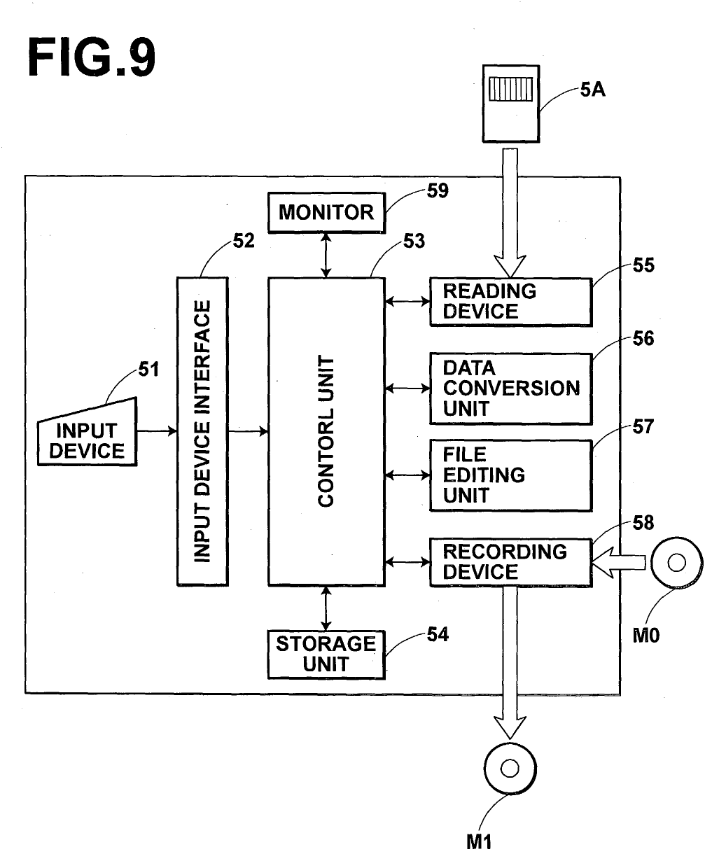

FIG. 9 is a block diagram showing a configuration of the image recording apparatus in this embodiment. The image recording apparatus has a different configuration for a recording medium for a DVD-Video reproduction apparatus and for a recording medium for a Video-CD reproduction apparatus. In FIG. 9, components that are common for the both cases are shown.

As shown in FIG. 9, the image recording apparatus comprises an input device 51 comprising a keyboard and a mouse used for various kinds of inputs, an input device interface 52, a control unit 53 for controlling the entire apparatus, a storage unit 54 for storing control programs and data necessary for control, a reading device 55 for reading the content of a memory card 5A having image data sets obtained by a digital camera therein, a data conversion unit 56 for converting a selected portion of the image data sets in the memory card 5A into an image data set or image data sets in a format for a DVD-Video reproduction apparatus or a Video-CD reproduction apparatus, a file editing unit-57 for organizing the converted image data set or sets into a file or files and for editing the file or files together with a file or files of the selected image data set or sets stored in the memory card 5A, a recording device 58 for recording the files output from the file editing unit 57 in a blank recording medium M0 in formats enabling reproduction by a computer and either a DVD-Video reproduction apparatus or a Video-CD reproduction apparatus to obtain a recording medium M1 having the files recorded therein, and a monitor 59 for display.

An input representing selection of a first image data set or first image data sets (hereinafter referred to as the first image data sets) to be recorded in the blank recording medium M0 from the image data sets recorded in the memory card 5A, and an input of conversion instruction for converting the first image data sets into a second image data set or second image data sets (hereinafter referred to as the second image data sets) in either the DVD-Video format or the Video-CD format are input from the input device 51, for example. In the case where the DVD-Video format is adopted, a selection for using or not using “switching effect” or the like is also input from the input device 51. An instruction for specifying how many seconds one still image is displayed in a moving image included in the second image data sets is also input from the input device 51.

The control unit 53 sequentially loads and starts the control programs stored in the storage unit 54. These control programs have been generated for control of each of the components upon necessity. The control unit 53 also displays a GUI for the control programs on the monitor 59 so that the control programs are executed as a user wishes, according to an input from the input device 51.

In this embodiment, the control unit 53 is operated by the control programs to enable calculation and display on the monitor 59 a data size of the first image data sets selected from the image data sets recorded in the memory card 5A to be recorded in the blank recording medium M0 as well as a data size of the second image data sets obtained by conversion of the first image data sets into the DVD-Video format or the Video-CD format.

The reading device 55 reads the image data sets recorded in the memory card 5A inserted therein.

The data conversion unit 56 converts the first image data sets into the second image data sets in either the DVD-Video format or the Video-CD format. The data conversion unit 56 comprises means for compressing the first image data sets, means for converting the compressed first image data sets into the format reproducible by a DVD-Video reproduction apparatus or a Video-CD reproduction apparatus, means for copying the converted image data sets according to the number instructed via the input device 51, means for arranging the copied image data sets as shown in FIG. 4 for enabling moving image display, and means for laying out data corresponding to a caption function and the like.

The data conversion unit 56 adjusts the first image data sets to be recorded in the blank recording medium M0 so as to have a quality instructed via the input device 51. In the case where the number of the first image data sets is not one, the adjustment is carried out for a selected portion of the first image data sets. For example, in the case where image reduction is instructed regarding some of the first image data sets for decreasing the data size, the corresponding first image data set or sets are subjected to image reduction. In the case of instruction of image quality degradation for some of the first image data sets, the corresponding first image data set or sets are subjected to image quality degradation.

The file editing unit 57 organizes the first image data sets into the files and organizes the second image data sets obtained by the data conversion unit 56 into the files by attaching directory information thereto. The file editing unit 57 also edits the files of the first image data sets and the second image data sets, and outputs the edited files as image files reproducible by a computer and either a DVD-Video reproduction apparatus or a Video-CD reproduction apparatus. The calculated data sizes of the first and second image data sets refer to the data sizes of the first and second image data sets that have been organized into the files by the file editing unit 57.

When the first image data sets are organized into the files, an html file or html files (hereinafter referred to as the html files) necessary for viewing the first image data sets on a personal computer is also generated.

The recording device 58 records the image files obtained by the file editing unit 57 in the blank recording medium M0, and obtains the recording medium M1.

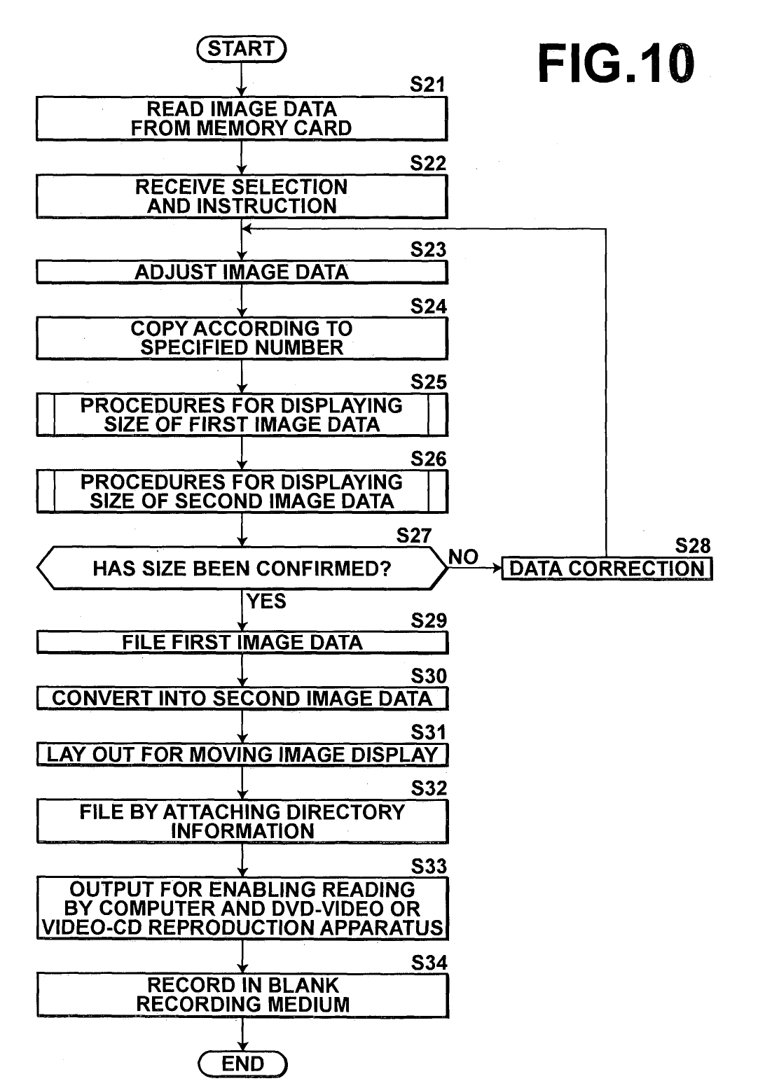

The operation of the image recording apparatus will be explained next. FIG. 10 is a flow chart showing procedures carried out by the image recording apparatus. The reading device 55 reads the image data sets from the memory card 5A (Step S21). The selection of the first image data sets to be recorded in the blank recording medium M0, a selection of audio data if necessary, and the instruction of image quality regarding the first image data sets (referred to as selection and instruction in FIG. 10) are then received (Step S22). The first image data sets that have been selected are adjusted to have the instructed quality (Step S23), and then copied as specified (Step S24).

In the case where the number of the first image data sets is not one, the procedure at Step S23 is carried out on the selected portion of the first image data sets.

The procedures for displaying the data size of the first image data sets (step S25) and the procedures for displaying the size of the second image data sets (Step S26) are then carried out.

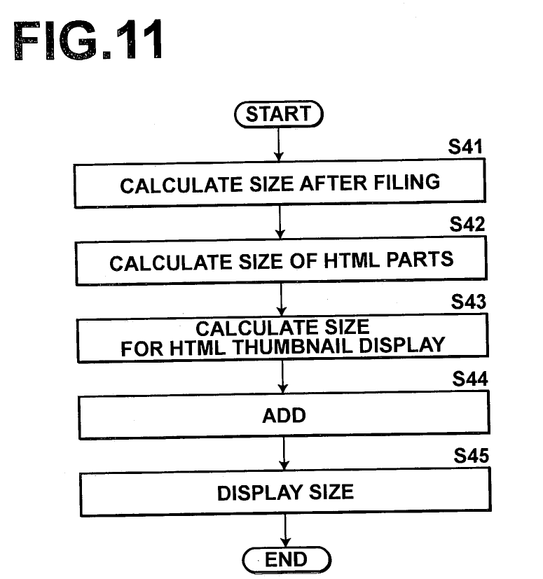

FIG. 11 is a flow chart showing the procedures of displaying the size of the first image data sets. A size of the first image data sets, if organized into the files, is calculated (Step S41). A size of the parts of the html files to view the first image data sets on a personal computer is then calculated (Step S42). A size of the thumbnail files generated from the first image data sets is also calculated (Step S43), and the sizes are then added up (Step S44). A result of the addition is displayed on the monitor 59 as the size of the first image data sets. (Step S45).

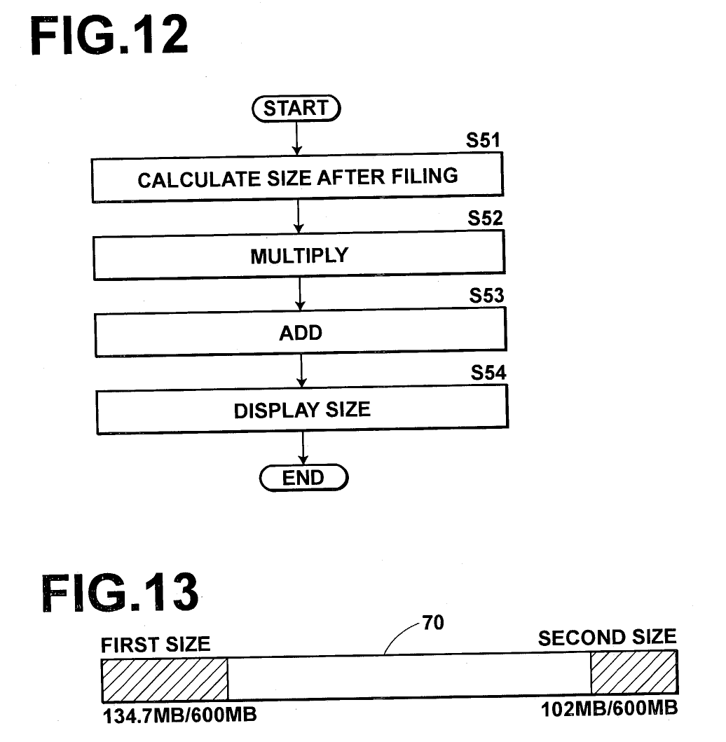

FIG. 12 is a flow chart showing the procedures for displaying the size of the second image data sets. A size of each of the second image data sets, if organized into the file, is calculated (Step S51). A size of each of the second image, data sets, the number of bits per second therein, and the time of reproduction therefor are multiplied together for each of the second image data sets (Step S52). All results at Step S52 are then added up, and a size of the audio data is also added thereto (Step S53). A result of the addition is displayed on the monitor 59 as the size of the second image data sets (Step S54).

FIG. 13 shows an example of how the sizes of the first and second image data sets are displayed. In the example shown in FIG. 13, the first data size occupies 134.7 MB out of 600 MB, and the second data size is 102 MB out of the 600 MB. A size display bar 70 is shown for visually displaying proportions of the data sizes in the capacity of the blank recording medium M0. The horizontal length of the size display bar 70 represents the capacity of the blank recording medium M0, and hatched areas in the left and right thereof represent the proportions of the first image data sets and the second image data sets in the capacity, respectively.

In FIG. 10, the user confirms the sizes of the first image data sets and the second image data sets, and whether or not the user inputs an agreement for the sizes is then judged (Step S27). If a result at Step S27 is negative, data correction including reduction of the first image data sets in number or quality, or deletion or curtailment of the audio data is carried out (Step S28) to return to Step S23. Thereafter, the procedures from Step S23 are carried out.

If the result at Step S27 is affirmative, the first image data sets are organized into the files (Step S29). The first image data sets are then converted into the DVD-Video format or the Video-CD format (Step S30), and the converted image data sets are arranged so as to enable reproduction of moving images in the form of a slide show. In this manner, the second image data sets are obtained (Step S31). The directory information is added thereto to organize the second image data sets into the files (Step S32). The filed first image data sets and the second image data sets are output as the image files reproducible by a computer and either a DVD-Video reproduction apparatus or a Video-CD reproduction apparatus (Step S33). The recording device 58 records the first image data sets and the second image data sets in the recording medium M0 for obtaining the recording medium M1 (Step S34) to end the procedures.

As has been described above, according to the image recording apparatus, the sizes of the first and second image data sets are calculated and displayed on the monitor 59 as shown in FIG. 13, for example. Therefore, by referring to the sizes of the first and second image data sets displayed on the monitor 59, the first and the second image data sets are subjected to number reduction or quality change according to the sizes. In this manner, the first and second image data sets can be recorded in the recording medium within the capacity of the recording medium.

What is claimed is:

1. An image reproduction apparatus for reproducing first image data and second image data recorded in a recording medium having a first image area storing, the, first image data for computer processing and a second image area storing the second image data for digital video equipment using the first image data as a source, the image reproduction apparatus comprising:
display control means for displaying on display means a selection screen for receiving selection of the first image area or the second image area;
selection reception means for receiving the selection of the first image area or the second image area in the selection screen; and
reproduction control means for reproducing the first image data in the first image area in the case where the first image area has been selected and for reproducing the second image data in the second image area in the case where the second image area has been selected.

2. An image reproduction apparatus as defined in claim 1, wherein the recording medium is a DVD-type recording medium and the second image data are image data of a DVD-Video format.

3. An image reproduction apparatus as defined in claim 1, wherein the recording medium is a CD-type recording medium and the second image data are image data of a Video-CD format.

4. An image reproduction apparatus as defined in claim 1, wherein the selection reception means is means for receiving the selection of the first image area or the second image area by an operation of a remote controller.

5. An image reproduction method for reproducing first image data and second image data recorded in a recording medium having a first image area storing the first image data for computer processing and a second image area storing the second image data for digital video equipment using the first image data as a source, the image reproduction method comprising the steps of:
displaying on display means a selection screen for receiving selection of the first image area or the second image area;
receiving the selection of the first image area or the second image area in the selection screen; and
reproducing the first image data stored in the first image area in the case where the first image area has been selected; and
reproducing the second image data stored in the second image area in the case where the second image area has been selected.

6. A program for causing a computer to execute an image reproduction method for reproducing first image data and second image data recorded in a recording medium having a first image area storing the first image data for computer processing and a second image area storing the second image data for digital video equipment using the first image data as a source, the program comprising the steps of:
displaying on display means a selection screen for receiving selection of the first image area or the second image area;
receiving the selection of the first image area or the second image area in the selection screen; and
reproducing the first image data stored in the first image area in the case where the first image area has been selected; and
reproducing the second image data stored in the second image area in the case where the second image area has been selected.

7. An image recording apparatus for recording, in a recording medium, first image data for computer processing and second image data for digital video equipment using the first image data as a source, the image recording apparatus comprising:
display control means for calculating a first data size regarding the first image data and a second data size regarding the second image data, and for displaying the first data size and the second data size on display means.

8. An image recording apparatus as defined in claim 7, wherein the recording medium is a DVD-type recording medium and the second image data are image data of a DVD-Video format.

9. An image recording apparatus as defined in claim 7, wherein the recording medium is a CD-type recording medium and the second image data are image data of a Video-CD format.

10. An image recording method for recording, in a recording medium, first image data for computer processing and second image data for digital video equipment using the first image data as a source, the image recording method comprising the steps of:
calculating a first data size regarding the first image data and a second data size regarding the second image data; and
displaying the first data size and the second data size on display means.

11. A program for causing a computer to execute an image recording method for recording, in a recording medium, first image data for computer processing and second image data for digital video equipment using the first image data as a source, the program comprising the steps of:
calculating a first data size regarding the first image data and a second data size regarding the second image data; and
displaying the first data size and the second data size on display means.
